(19) United States
(12) Patent Application Publication
(10) Pub. No.: US 2025/0356127 A1
(43) Pub. Date: Nov. 20, 2025

(54) SECURITY LOG TYPE CLASSIFICATION WITH AN ARTIFICIAL INTELLIGENCE MODEL

(71) Applicant: Google LLC, Mountain View, CA (US)

(72) Inventors: Shapor Naghibzadeh, Mountain View, CA (US); Pranjal Gupta, Madhya Pradesh (IN); Sunil Vasisht, Frisco, TX (US); Adam Licata, South Orange, NJ (US)

(21) Appl. No.: 19/206,498

(22) Filed: May 13, 2025

(30) Foreign Application Priority Data
May 16, 2024 (IN) 202441038468

(51) Int. Cl. G06F 40/284; G06F 21/54

(52) U.S. Cl. CPC G06F 40/284; G06F 21/54

(57) ABSTRACT

A system and method for security log classification using an artificial intelligence (AI) model. The method includes obtaining a log comprising a sequence of characters, extracting, using a token vocabulary, a sequence of tokens from the sequence of characters, providing the sequence of tokens as input to a trained artificial intelligence (AI) model, obtaining one or more outputs from the trained AI model, and extracting, from the one or more outputs, (i) a label reflecting a type of log, and (ii) a level of confidence that the label applies to the log.

### CLAIM OF PRIORITY

The present application claims the benefit under 35 U.S.C. § 119(c) of Indian Provisional Patent Application No. 202441038468 filed May 16, 2024, which is incorporated by reference herein.

### TECHNICAL FIELD

The present disclosure relates generally to cloud-based cybersecurity platforms. In particular, aspects and implementations of the present disclosure relate to security log type classification with an artificial intelligence (AI) model.

### BACKGROUND

In today's digital age, organizations are constantly facing an increasing volume of sophisticated cybersecurity threats. Cybersecurity is the practice of protecting systems, networks, and data from digital attacks, unauthorized access, and damage. Traditional cybersecurity measures are often inadequate in providing comprehensive protection against such threats, which has resulted in the proliferation of large numbers of disparate cybersecurity operations tools such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. Each of these tools can generate large amounts of cybersecurity data, which is often formatted according to diverse structures or formats that are not easily combined or reconciled with one another. Analyzing and acting upon the staggering volume and diversity of data generated by such an ever-increasing number of cybersecurity operations tools is complex and cumbersome, leading to inefficiencies and vulnerabilities.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including: obtaining a log comprising a sequence of characters; extracting, using a token vocabulary, a sequence of tokens from the sequence of characters; providing the sequence of tokens as an input to a trained artificial intelligence (AI) model; obtaining one or more outputs from the trained AI model; and extracting, from the one or more outputs, (i) a label reflecting a type of log, and (ii) a level of confidence that the label applies to the log.

Aspects of the disclosure further include: wherein extracting the sequence of tokens from the sequence of characters further comprises: splitting the sequence of characters into a sequence of strings, each string comprising at least one character of the sequence of characters; determining, for each string of the sequence of strings, whether a portion of the string matches a token of the token vocabulary; responsive to determining that the portion of the string matches the token, discarding a remainder of the string.

Aspects of the disclosure further include: determining whether the level of confidence satisfies a threshold criterion; and responsive to determining the level of confidence satisfies the threshold criterion, assigning the label to the log.

Aspects of the disclosure further include: determining whether the level of confidence satisfies a threshold criterion; responsive to determining that the level of confidence does not satisfy the threshold criterion, causing a visual representation of (i) the label reflecting the type of log and (ii) the level of confidence that the label applies to the log to be visually rendered via a graphical user interface (GUI) in association with a prompt to select a selected label to be associated with the log; and assigning the selected label to the log.

Aspects of the disclosure further include: extracting, from the one or more outputs, (iii) an indication of a second label, and (iv) a second level of confidence that the second label applies to the log.

Aspects of the disclosure further include: extracting, from the one or more outputs (iii) an indication of security information, and (iv) a second level of confidence that the security information applies to the log.

Aspects of the disclosure further include: splitting the sequence of characters into a sequence of strings, each string comprising at least one character of the sequence of characters; determining, for each string of the sequence of strings, whether a portion of the string satisfies a frequency criterion; responsive to determining that the portion of the string satisfies the frequency criterion, adding the portion of the string that satisfies the frequency criterion to the token vocabulary.

Aspects of the disclosure further include: generating a plurality of strings comprising a first sequence of strings and a second sequence of strings, wherein generating the plurality of comprises: splitting the sequence of characters into the first sequence of strings each string comprising at least one character of the first sequence of characters, and splitting a second sequence of characters from a second log into the second sequence of strings, each string comprising at least one character of the second sequence of characters; determining, for each string of the plurality of strings, whether a portion of the string satisfies a frequency criterion; responsive to determining that the portion of the string satisfies the frequency criterion, adding the portion of the string that satisfies the frequency criterion to the token vocabulary.

An aspect of the disclosure provides a non-transitory computer readable storage medium comprising instructions for a server that, when executed by a processing device, cause the processing device to perform operations comprising: obtaining a log comprising a sequence of characters; extracting, using a token vocabulary, a sequence of tokens from the sequence of characters; providing the sequence of tokens as an input to a trained artificial intelligence (AI) model; obtaining one or more outputs from the trained AI model; and extracting, from the one or more outputs, (i) a label reflecting a type of log, and (ii) a level of confidence that the label applies to the log.

Aspects of the disclosure further include: splitting the sequence of characters into a sequence of strings, each string comprising at least one character of the sequence of characters; determining, for each string of the sequence of strings, whether a portion of the string matches a token of the token vocabulary; responsive to determining that the portion of the string matches the token, discarding a remainder of the string.

Aspects of the disclosure further include: determining whether the level of confidence satisfies a threshold criterion; and responsive to determining the level of confidence satisfies the threshold criterion, assigning the label to the log.

Aspects of the disclosure further include: determining whether the level of confidence satisfies a threshold criterion; responsive to determining that the level of confidence does not satisfy the threshold criterion, causing a visual representation of (i) the label and (ii) the level of confidence that the label applies to the log to be visually rendered via a graphical user interface (GUI) in association with a prompt to select a selected label to be associated with the log; and assigning the selected label to the log.

Aspects of the disclosure further include: extracting, from the one or more outputs, (iii) an indication of a second label, and (iv) a second level of confidence that the second label applies to the log.

Aspects of the disclosure further include: extracting, from the one or more outputs (iii) an indication of security information, and (iv) a second level of confidence that the security information applies to the log.

Aspects of the disclosure further include: splitting the sequence of characters into a sequence of strings, each string comprising at least one character of the sequence of characters; determining, for each string of the sequence of strings, whether a portion of the string satisfies a frequency criterion; responsive to determining that the portion of the string satisfies the frequency criterion, adding the portion of the string that satisfies the frequency criterion to the token vocabulary.

Aspects of the disclosure further include: generating a plurality of strings comprising a first sequence of strings and a second sequence of strings, wherein generating the plurality of comprises: splitting the sequence of characters into the first sequence of strings, and splitting a second sequence of characters from a second log into the second sequence of strings; determining, for each string of the plurality of strings, whether a portion of the string satisfies a frequency criterion; responsive to determining that the portion of the string satisfies the frequency criterion, adding the portion of the string that satisfies the frequency criterion to the token vocabulary.

An aspect of the disclosure provides a system with a memory and one or more processing devices coupled with the memory, the one or more processing devices to perform a computer-implemented method including: obtaining a log comprising a sequence of characters; extracting, using a token vocabulary, a sequence of tokens from the sequence of characters; providing the sequence of tokens as an input to a trained artificial intelligence (AI) model; obtaining one or more outputs from the trained AI model; and extracting, from the one or more outputs, (i) a label reflecting a type of log, and (ii) a level of confidence that the label applies to the log.

Aspects of the disclosure further include: splitting the sequence of characters into a sequence of strings, each string comprising at least one character of the sequence of characters; determining, for each string of the sequence of strings, whether a portion of the string matches a token of the token vocabulary; responsive to determining that the portion of the string matches the token, discarding a remainder of the string.

Aspects of the disclosure further include: determining whether the level of confidence satisfies a threshold criterion; and responsive to determining the level of confidence satisfies the threshold criterion, assigning the label to the log.

Aspects of the disclosure further include: determining whether the level of confidence satisfies a threshold criterion; responsive to determining that the level of confidence does not satisfy the threshold criterion, causing a visual representation of (i) the label and (ii) the level of confidence that the label applies to the log to be visually rendered via a graphical user interface (GUI) in association with a prompt to select a selected label to be associated with the log; and assigning the selected label to the log.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, in accordance with aspects of the disclosure.

FIG. 2 is an example training set generator to generate training data for a machine learning model using information classification of log type, in accordance with aspects of the disclosure.

FIG. 3 depicts a flow diagram of one example of a method for training a AI model, in accordance with aspects of the disclosure.

FIG. 4 illustrates an example block diagram of a system flow for an AI model pipeline for security log classification with the AI model, according to aspects of the disclosure.

FIG. 5 illustrates an example swimlane diagram for a data flow for performing security log type classification with an AI model, according to aspects of the disclosure.

FIG. 6A illustrates an example method for predicting a security log type classification with an artificial intelligence model, according to aspects of the disclosure.

FIG. 6B illustrates an example method for predicting a security log type classification with an artificial intelligence model, according to aspects of the disclosure.

FIG. 7 illustrates an example method for predicting a security log type classification with an artificial intelligence model, according to aspects of the disclosure.

FIG. 8 is a block diagram illustrating an example of a computer system, in accordance with aspects of the disclosure.

### DETAILED DESCRIPTION

Aspects of the present disclosure relate to security log type classification with an artificial intelligence (AI) model. A security platform can service one or more clients (e.g., organizations and/or individual users). The security platform can be part of an online (e.g., virtual) platform that provides users or clients with a comprehensive suite of productivity tools, programs, and services. The security platform can combine the features of a SIEM and a SOAR into a unified platform. The security platform collects logs from a client and provides the client with tools to detect, analyze, and respond to incidents described in the collected logs. One or more features of the security platform can be automated or partially automated, including log collection actions, incident detection actions, data analysis actions, or incident response actions.

The security platform can provide a client with tools to manage computer and network security for the client. The security platform can provide a user (e.g., a systems administrator) from the client with a graphical user interface (GUI) to access and use the tools and functionality of the security platform.

The client can provide log data to the security platform. Once the security data ingests the log data from the client, the client can use the tools or services of the security platform to perform security actions with the log data. However, to provide log data to the security platform, then the organization may specify a type of each log in the log data.

Specifying the type of log for each type of log generated by the client can be a tedious manual process that may be prone to error. Some security platforms allow the client to provide logs to the security platform without a specific log type identification. However, these security platforms may often then manually classify the log types. Alternatively, these security platforms provide limited feature functionality for non-specified log types provided by a client.

Aspects of the present disclosure address the above noted and other deficiencies by providing for security log type classification with an AI model. The security platform can obtain logs from clients. Each log can be a sequence of characters (e.g., a sequence of strings delimited by a predefined delimiter, such as a whitespace and or carriage return (CR) or line feed (LF) symbol). Each sequence of characters can be used as input to a trained AI model that produces a log type label for the sequence of characters as an output. To reduce the size of the input to the AI model, the security platform can extract a sequence of prevalent strings from the sequence of characters. The sequence of prevalent strings, (also referred to as a sequence of tokens) can be used as a smaller-sized input to the AI model. The security platform can use a token vocabulary containing dictionary strings to extract the sequence of tokens from the sequence of characters. For example, given a token vocabulary of [red, yellow, blue], the security platform can extract [red, blue] as the sequence of tokens from the sequence of characters [the red ball bounced into the blue pond]. The security platform can provide the sequence of tokens to the AI model as input, and receive the log type label as output from the AI model.

In some embodiments, the token vocabulary includes multiple “dictionary tokens.” The dictionary tokens can be identified and added to the token vocabulary based on logs received at the security platform. In some embodiments, strings that frequently occur across multiple logs for a particular log type can be identified as dictionary tokens and added to the token vocabulary.

The security platform can use the AI model to identify a label for the log, and either assign the label to the log or suggest the label for the log to a user. In some embodiments, the security platform can assign the label generated by the AI model to the log. In some embodiments, the label is if a level of confidence satisfies a threshold level of confidence. In some embodiments, the label can be assigned by the security platform based on an input received from a GUI.

In some embodiments, the AI model can identify two or more labels that may apply to the log. In such embodiments, the security platform can select the label having a higher level of confidence to assign to the log or prompt a user to select which of the two or more labels should be assigned to the log.

In some embodiments, there may not be a predefined label (maintained by the security platform) that applies a given log. In such embodiments, the security platform can prompt a user of the client to provide metadata associated with the log. The metadata can include one or more of a client log type, application data, network data, computing device data, or the like. In some embodiments, using the metadata, the security platform may generate a new label that will apply to the provided log.

Advantages of implementing security log classification with an AI model include improving client log identification accuracy, simplifying the configuration of security platform preferences related to the received client log, improving the efficiency of the configuration of security platform preferences, reducing the time to configure the security platform for the client, and improving the functionality of security platform tools and features available to clients.

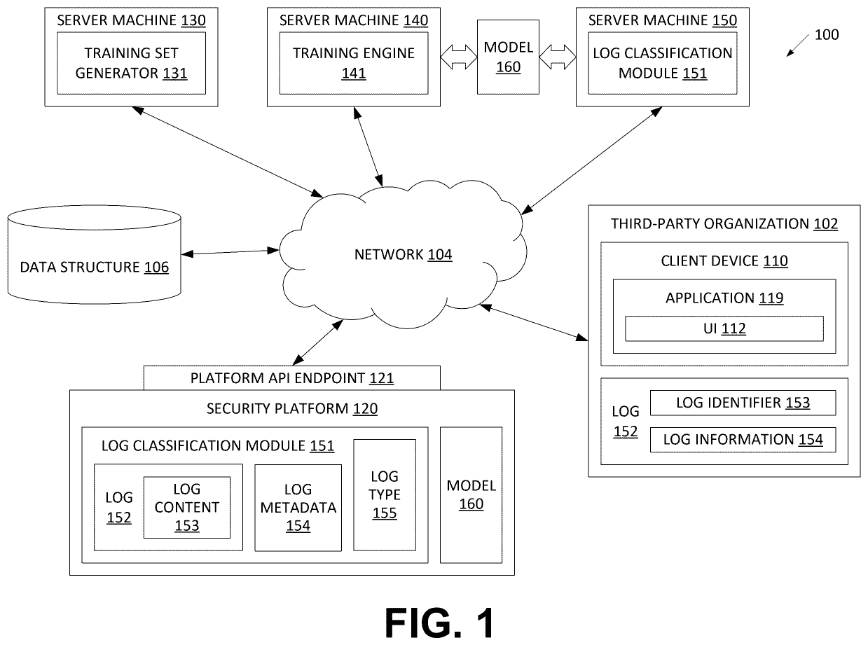

FIG. 1 illustrates an example of a system 100, in accordance with aspects of the disclosure. The system 100 includes a security platform 120, one or more server machines 130-150, a data structure 106, and client device 110 connected to network 104. In some embodiments, system 100 can include one or more other platforms (such as those illustrated in FIG. 1B).

In some embodiments, network 104 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data structure 106 can be a persistent storage that is capable of storing data such as log information (e.g., sequences of characters in a log), labels reflecting a type of log, and the like. Data structure 106 can be hosted by one or more storage devices, such as main memory, magnetic or optical storage based disks, tapes or hard drives, network-attached storage (NAS), storage area network (SAN), and so forth. In some embodiments, data structure 106 can be a network-attached file server, while in other embodiments the data structure 106 can be another type of persistent storage such as an object-oriented database, a relational database, and so forth, that can be hosted by security platform 120, or one or more different machines coupled to the server hosting the security platform 120 via the network 104. In some embodiments, data structure 106 can be capable of storing one or more data items, as well as data structures to tag, organize, and index the data items. A data item can include various types of data including structured data, unstructured data, vectorized data, etc., or types of digital files, including text data, audio data, image data, video data, multimedia, interactive media, data objects, and/or any suitable type of digital resource, among other types of data. An example of a data item can include a file, database record, database entry, programming code or document, among others.

The client device(s) (e.g., client device 110) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. In some embodiments, client device(s) may also be referred to as a “user device” herein. Although a single client device 110 is shown for purposes of illustration rather than limitation, one or more client devices can be implemented in some embodiments. Client device 110 will be referred to as client device 110 or client devices 110 interchangeably herein.

In some embodiments, a client device, such as client device 110, can implement or include one or more applications. In some embodiments, application 119 can be used to communicate (e.g., send and receive information) with the security platform 120. In some embodiments, application 119 can implement user interfaces (UIs) (e.g., graphical user interfaces (GUIs)), such as a user interface (UI) (e.g., UI 112) that may be webpages rendered by a web browser and displayed on the client device 110 in a web browser window. In another embodiment, the UIs 112 of client application, such as application 119 may be included in a stand-alone application downloaded to the client device 110 and natively running on the client device 110 (also referred to as a “native application” or “native client application” herein). In some embodiments, log classification module 151 can be implemented as part of application 119. In other embodiments, log classification module 151 can be separate from application 119 and application 119 can interface with log classification module 151.

In some embodiments, one or more client devices 110 can be connected to the system 100. In some embodiments, client devices, under direction of the security platform 120 when connected, can present (e.g., display) a UI 112 to a user of a respective client device through application 119. The client devices 110 may also collect input from users through input features.

In some embodiments, a UI 112 may include various visual elements (e.g., UI elements) and regions, and can be a mechanism by which the user engages with the security platform 120, and system 100 at large. In some embodiments, the UI 112 of a client device 110 can include multiple visual elements and regions that enable presentation of information, for decision-making, content delivery, etc. at a client device 110. In some embodiments, the UI 112 may sometimes be referred to as a graphical user interface (GUI)).

In some embodiments, the UI 112 and/or client device 110 can include input features to intake information from a client device 110. In one or more examples, a user of client device 110 can provide input data (e.g., a user query, control commands, etc.) into an input feature of the UI 112 or client device 110, for transmission to the security platform 120, and system 100 at large. Input features of UI 112 and/or client device 110 can include space, regions, or elements of the UI 112 that accept user inputs. For example, input features may include visual elements (e.g., GUI elements) such as buttons, text-entry spaces, selection lists, drop-down lists, etc. For example, in some embodiments, input features may include a chat box which a user of client device 110 can use to input textual data (e.g., a user query). The application 119 via client device 110 can then transmit that textual data to security platform 120, and the system 100 at large, for further processing. In other examples, input features can include a selection list, in which a user of client device 110 can input selection data e.g., by selecting, or clicking. The application 119 via client device 110 can then transmit that selection data to security platform 120, and the system 100 at large, for further processing.

In some embodiments, a client device 110 can access the security platform 120 through network 104 using one or more application programming interface (API) calls via platform API endpoint 121. In some embodiments, security platform 120 can include multiple platform API endpoints 121 that can expose services, functionality, or information of the security platform 120 to one or more client devices 110. In some embodiments, a platform API endpoint 121 can be one end of a communication channel, where the other end can be another system, such as a client device 110 associated with a user account. In some embodiments, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some embodiments, HTTP (Hypertext Transfer Protocol), HTTPS (Hypertext Transfer Protocol Secure) methods (e.g., API calls) can be used to communicate to and from the platform API endpoint 121.

In some embodiments, the platform API endpoint 121 can function as a computer interface through which access requests are received and/or created. In some embodiments, the platform API endpoint 121 can include a platform API whereby external entities or systems can request access to services and/or information provided by the security platform 120. The platform API can be used to programmatically obtain services and/or information associated with a request for services and/or information.

In some embodiments, the API of the platform API endpoint 121 can be any suitable type of API such as a REST (Representational State Transfer) API, a GraphQL API, a SOAP (Simple Object Access Protocol) API, and/or any suitable type of API. In some embodiments, the security platform 120 can expose through the API, a set of API resources which when addressed can be used for requesting different actions, inspecting state or data, and/or otherwise interacting with the security platform 120. In some embodiments, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the security platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some embodiments, any element, such as server machine 130, server machine 140, server machine 150, and/or data structure 106 may include a corresponding API endpoint for communicating with APIs.

In some embodiments, the security platform 120 may include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security platform 120 can include a plurality of computing devices that together may comprise a hosted computing resource, a grid computing resource, or any other distributed computing arrangement. In some embodiments, the security platform 120 can correspond to an elastic computing resource where the allotted capacity of processing, network, storage, or other computing-related resources may vary over time.

In some embodiments, the security platform 120 can include one or more features to collect, analyze, and respond to security data received from a client 102. The security platform can collect security logs (e.g., the log 152) from the client 102 and arrange the data in the security logs (e.g., log contents 153, log metadata 154) into universal format. In some embodiments, the security platform 120 includes a centralized security data ingestion point. In some embodiments, one or more aspects of the collection of the log 152 from the client 102 are automated or partially automated. In some embodiments, the log content 153 and log metadata 154 can be stored in the data structure 106. The security platform 120 can provide the client 102 with tools to analyze the log content 153 and/or log metadata 154 of the log 152 received from the client 102. In some embodiments, the log content 153 and/or log metadata 154 can be labeled or tagged to allow the client 102 to query the centralized data structure where the log content and/or log metadata 154 are stored. In some embodiments, one or more aspects of the tools to analyze the information extracted from the log 152 can be automated or partially automated. The security platform 120 can provide the client 102 with tools to perform one or more actions based on information extracted from the log 152 received from the client 102 (e.g., information reflected in the log content 153 and/or log metadata 154 of the log 152). In some embodiments, the security platform 120 can allow the client 102 to configure certain security response parameters related to performing one or more actions based on information extracted from the log 152 received from the client 102. For example, the security platform can allow the client to indicate a particular security action that is to be triggered when the security platform detects a particular sequence of characters within log content 153 of the log 152. In some embodiments, one or more aspects of the tools to perform one or more actions based on the information extracted from the log 152 can be automated or partially automated.

The security platform 120 can implement a log classification module 151. The log classification module 151 can implement one or more features and/or operations as described herein. The log classification module 151 can include or access the model 160. In some embodiments, the security platform 120 receives logs 152 from a client 102. A log 152 can include data that pertains to a particular log received from the client 102. The log classification module 151 can process a log 152 to obtain a log type 155. In some embodiments, the log classification module 151 provides an indication of the log 152 as an input to the model 160 and receives a log type 155 as an output from the model 160. As used herein, “log type” refers to an internal label assigned by the security platform 120 to a log 152 that is received from a client 102.

A log 152 can include log content 153. In some embodiments, the log 152 is associated with log metadata 154. The log metadata 154 can be generated by applications, systems, or processes of the client 102 when generating log content 153 for a particular log. In some embodiments, log metadata 154 can include one or more of a log identifier, a client label reflecting a client log type, a source of the log 152, or the like.

Log content 153 can be generated by the client 102 and can include information describing activities in a computing environment of the client 102 (e.g., including client device 110, application 119, etc.). In some embodiments, the log content 153 includes details about the activity that the client 102 can use to analyze the activity, respond to an event, or implement policies to avoid, or promote similar activity in the future. In some embodiments, tools, applications, or systems of or used by the client 102 can generate log content 153. For example, log content 153 for the log 152 can be generated in response to the client detecting an intrusion into an internal network. In another example, log content 153 for the log 152 can be generated in response to a malfunction of a computer device (e.g., client device 110) or application (e.g., application 119) of the client 102.

In some embodiments, the log content 153 includes one or more entries, such that each log entry includes, e.g., temporal data (e.g., a timestamp), an event description, network data (e.g., internet protocol (IP) address(es), network traffic data, or network configuration data), a user identification, system information (e.g., a computing environment of the client), security context information, or the like. In some embodiments, log content 153 is represented by a sequence of characters which form a sequence of strings delimited by a predefined delimiter, such as a whitespace, or a CR or LF symbol. In some embodiments, the sequence of characters includes Unicode™ characters. In some embodiments, the log content 153 includes information related to the client 102. For example, log information in a log from Organization A using Application X can include Organization A information and Application X information, while log information in a log from Organization B using Application X may only include Application X information.

In some embodiments, the log content 153 can include client-specific data. In some embodiments, despite including client-specific data, a portion of the log content 153 for logs received from different clients (e.g., client 102) can be the same or similar. The security platform 120 (e.g., using log classification module 151) can identify log content 153 in different logs received from different clients as the same or similar, and assign a label reflecting the log type 155 (e.g., a universal log type label for the security platform 120). In some embodiments, the log metadata 154 can include organization-specific data. In some embodiments, a portion of the log metadata 154 can be used to identify a log type 155 of the log 152.

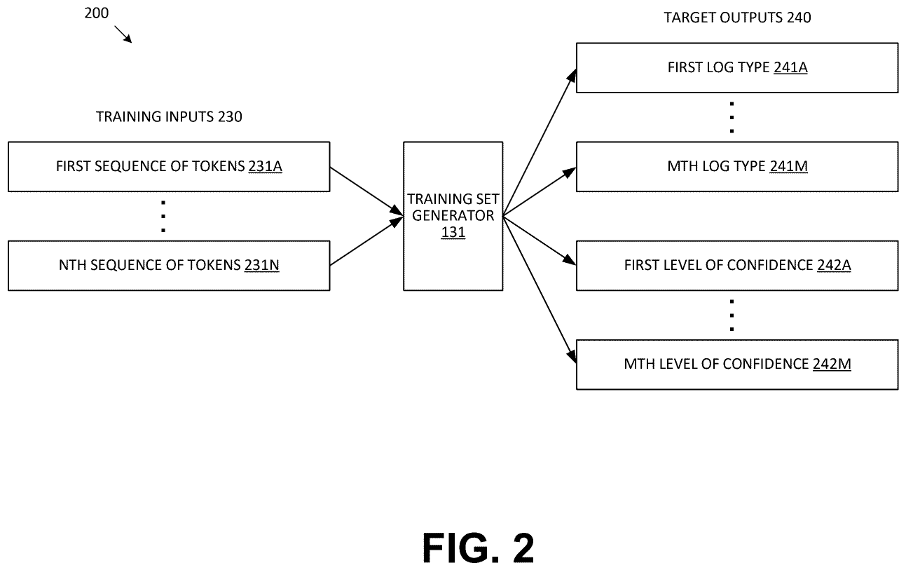

The security platform 120 can feed the log content 153 to the log classification module 151. In some embodiments, the log classification module 151 can feed the log content 153 to the model 160. In some embodiments, the log classification module 151 can receive the label reflecting the log type 155 from the model 160. The log classification module 151 can feed the label reflecting the log type 155 to the security platform 120.log content 153. In some embodiments, the log classification module 151 can generate inputs for training the model 160 (e.g., using the training set generator 131). Additional details regarding the use of the training set generator 131 are described below with reference to FIG. 2. In some embodiments, preprocessing performed by the log classification module 151 includes extracting a sequence of tokens from the log content 153. In some embodiments, the log content 153 includes a sequence of characters. The sequence of characters may be viewed as a sequence of strings that are delimited by a predefined delimiter (e.g., a whitespace, or a CR or LF symbol). In some embodiments, the strings are human-recognizable (e.g., “words”). For example, given the log content 153 [the red apple fell in the pond], a corresponding sequence of strings can be [the, red, apple, fell, in, the, pond]. In some embodiments, the log classification module 151 parses the log content 153 into a sequence of strings, substrings, and wildcards. For example, given the log content 153 [the sunset was a reddish gold], a corresponding sequence of strings, substrings, and wildcards can be [the, sun, ##set, was, a, red, ##ish, gold]. The “##” used here is to represent a wildcard indicating that the characters that follow (e.g., a substring) were originally part of another string. It can be appreciated that other wildcard conventions are possible, and that the use of “##” is merely exemplary. In some embodiments, substrings are identified and separated from strings based on a token vocabulary, or string-prevalence, as described in the following paragraphs. That is, if a substring of a string matches a common string (in the above example, “sun,” and “red”), the common matching substrings can be extracted from the original string, and the remaining characters can be represented as substrings attached to wildcard characters (as described in the above example).

In some embodiments, preprocessing performed by the log classification module includes splitting the log content 153 into a sequence of dictionary tokens. A “dictionary token” can be a particular string that satisfies a one or more threshold criteria for a log 152 received by the security platform 120. In some embodiments, the one or more threshold criteria can include a frequency criterion. In some embodiments, a set of prevalent strings are referred to as a “prevalent string vocabulary” or “token vocabulary.” The token vocabulary can be generated by parsing the log content 153 of historical logs into sequences of strings. The log classification module 151 can analyze the sequences of strings to identify strings that satisfy one or more threshold criteria (e.g., a frequency criterion). In some embodiments, the frequency criterion is based on a number of occurrences of a particular string. For example, the particular string occurs X times in log A, and Y times in log B. In some embodiments, the frequency criterion is based on a number of logs that includes the particular string. For example, the particular string occurs in X number of logs 152. In some embodiments, the frequency criterion is based on a total number of dictionary tokens in the token vocabulary. For example, the size of the token vocabulary (e.g., the number of dictionary tokens) can be limited to a maximum quantity. In some embodiments, a frequency criterion of the one or more threshold criteria can be based on an n-th most frequently occurring string(s) in multiple sequences of strings. For example, if the sequences of strings collectively have one hundred unique strings, each unique string having a respective occurrence frequency, the frequency criterion can be the ten (e.g., n-th) unique strings which occur most frequently. References to the strings that satisfy the one or more threshold criteria can be added to the token vocabulary (e.g., stored in a data structure associated with the token vocabulary, labeled with a token vocabulary label, etc.). In some embodiments, the log classification module 151 can periodically update the token vocabulary based on logs 152 that are received after the initial token vocabulary is generated (e.g., generated from historical logs). In some embodiments, the log classification module 151 analyzes the prevalence of strings in each type of log 152 (based on historically labeled logs), not necessarily on a particular log log type.

The log classification module 151 can provide the generated sequence of tokens to the model 160 as input. The log classification module 151 can obtain the log type 155 as output from the model 160. In some embodiments, the log classification module 151 can generate the sequence of tokens in similar fashion as the historical sequence of tokens was generated for training the model 160, as described above.

The model 160 can be trained to generate one or more outputs including (i) an indication of a label reflecting a type of the log 152 (e.g., log type 155), and (ii) a level of confidence that the label (e.g. log type 155) applies to the log 152.

In some embodiments, the security platform can receive logs 152 generated by a client 102 (e.g., a system administrator of the client 102) can provide the security platform 120 with logs 152 generated by the client 102. In some embodiments, the logs 152 are received one at a time. In some embodiments, the logs 152 are received as a list, group, table, or other data structure. In some embodiments, one or more of logs 152 are received discreetly (e.g., at specific times). In some embodiments, the logs 152 are received as a real-time data stream.

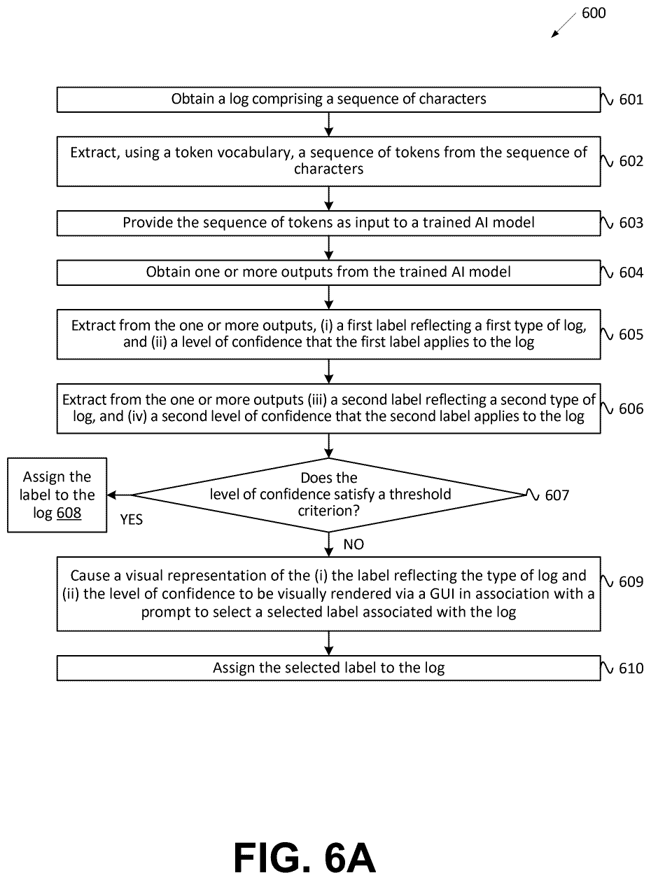

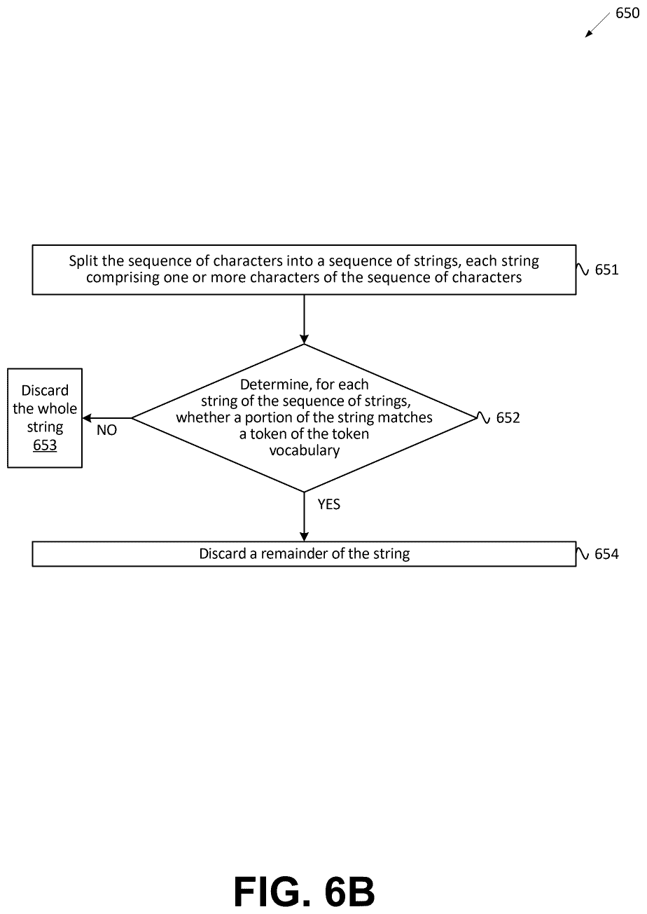

In some embodiments, for each log 152, the client 102 configures parameters of the security platform 120 based on the log type 155 (e.g., predicted by the model 160). In some embodiments, each log type 155 is configured individually. In some embodiments, multiple log types can be configured simultaneously (e.g., visually rendered simultaneously). In some embodiments, responsive to receiving a prediction of a log type 155 from the model 160, the security platform 120 can determine one or more related configuration parameters for the log type 155. In some embodiments, the security platform can change one or more configuration parameters related to analyzing the log 152 based on the log type 155 predicted by the model 160 for the log 152. In some embodiments, the security platform 120 provides a user interface (e.g., UI 112) for the client 102 to interface with the security platform 120 and/or the log classification module 151. In some embodiments, the security platform 120 can prompt the user to perform one or more actions based on an output from the model 160 (e.g., a log type 155). Additional details regarding using the model 160, and outputs from the model 160 are described with reference to FIG. 6A, below.

The log classification module 151 can obtain a log 152. In some embodiments, the log 152 is obtained from the data structure 106. In some embodiments, the log 152 is received from a client 102. The log classification module 151 can use a token vocabulary to extract a sequence of tokens from the log 152. In some embodiments, the sequence of tokens are extracted from the log content 153. In some embodiments, the log content 153 is represented by a sequence of characters. The log classification module 151 can provide the sequence of tokens as an input to the model 160. The model 160 can generate one or more outputs. The log classification module 151 can obtain the one or more outputs from the model 160. In some embodiments, the log classification module 151 receives the one or more outputs directly from the model 160. The log classification module 151 can extract information from the one or more outputs of the model 160. In some embodiments, the information includes a label reflecting a type of log (e.g., log type 155) for the input log (e.g., log 152). In some embodiments, the information includes a level of confidence that the label (e.g., log type 155) applies to the input log (e.g., log 152). In some embodiments, the information includes a second label reflecting a second type of log (e.g., log type 155) for the input log (e.g., log 152). In some embodiments, the information includes security information and a level of confidence that the security information applies to the input log (e.g., log 152). In some embodiments, the security information includes one or more of a security action or activity that can be performed at the security platform 120 or the client 102, a security report, or the like.

In some embodiments, the log classification module 151 can process a first batch (e.g., by sampling the historical log data) to perform an initial training of the model 160 and/or generate an initial token vocabulary, and continue fine-tuning the model 160 and token vocabulary by processing subsequent batches of the historical log data. In some embodiments, a separate system or process (not illustrated) can sample the historical log data (e.g., stored in data structure 106) and provide the sampled historical log data to the log classification module 151.

In some embodiments, security platform 120 may generate, modify, and monitor the client-side UIs (e.g., graphical user interfaces (GUI)) and associated components that are presented to users of the security platform 120 through UI 112 client devices 110. For example, log classification module 151 can generate the UIs (e.g., UI 112 of client device 110) that users interact with while engaging with the security platform 120.

In some embodiments, a machine learning model (e.g., also referred to as an “artificial intelligence (AI) model” herein) can include a discriminative machine learning model (also referred to as “discriminative AI model” herein), a generative machine learning model (also referred to as “generative AI model” herein), and/or other machine learning model.

In some embodiments, a discriminative machine learning model can model a conditional probability of an output for given input(s). A discriminative machine learning model can learn the boundaries between different classes of data to make predictions on new data. In some embodiments, a discriminative machine learning model can include a classification model that is designed for classification tasks, such as learning decision boundaries between different classes of data and classifying input data into a particular classification. Examples of discriminative machine learning models include, but are not limited to, support vector machines (SVM) and neural networks.

In some embodiments, a generative machine learning model learns how the input training data is generated and can generate new data (e.g., original data). A generative machine learning model can model the probability distribution (e.g., joint probability distribution) of a dataset and generate new samples that often resemble the training data. Generative machine learning models can be used for tasks involving image generation, text generation and/or data syn-thesis. Generative machine learning models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Training of and inference using discriminative machine learning models and generative machine learning models is described herein. It should be noted that although the training of and inference using discriminative machine learning model and generative machine learning model are described separately for the purposes of clarity, it can be appreciated that elements described with respect to discriminative machine learning models can apply to generative machine learning models, and vice versa, unless otherwise described.

In some embodiments, some elements of FIG. 1, such as training set generator 131 of server machine 130, training engine 141 of server machine 140, and model 160 can apply to a discriminative machine learning model, unless otherwise described.

Server machine 130 includes a training set generator 131 that is capable of generating training data (e.g., a set of training inputs and a set of target outputs) to train a model 160 (e.g., a discriminative machine learning model). In some embodiments, training set generator 131 can generate the training data based on various data (e.g., stored at data structure 106 or another data structure connected to system 100 via the network 104). The data structure 106 can store metadata associated with the training data.

Server machine 140 includes a training engine 141 that is capable of training a model 160 using the training data from training set generator 131. The model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs) (e.g., labels). The training engine 141 may find patterns in the training data that map the training input to the target output (the answer to be predicted) and provide the model 160 that captures these patterns. The model 160 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. Model 160 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some embodiments, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some embodiments, training data, such as training input and/or training output, and/or input data to a trained machine learning model (collectively referred to as “machine learning model data” herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some embodiments, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some embodiments, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.”

In some embodiments, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some embodiments embedding data can represent original data (e.g., word, phrase, document, or entity) as a vector in vector space, such as continuous vector space. Each element (e.g., dimension) of the vector can correspond to a feature or property of the original data (e.g., object). In some embodiments, the size of the embedding vector (e.g., embedding dimension) can be adjusted during model training. In some embodiments, the embedding dimension can be fixed to help facilitate analysis and processing of data by machine learning models.

In some embodiments, the training set is obtained from server machine 130. Server machine 150 includes a log classification module 151 that provides current data (e.g., log information, etc.) as input to the trained machine learning model (e.g., model 160) and runs the trained machine learning model (e.g., model 160) on the input to obtain one or more outputs.

In some embodiments, confidence data can include or indicate a level of confidence of that a particular output (e.g., output(s)) corresponds to one or more inputs of the machine learning model (e.g., trained machine learning model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some embodiments, confidence data can be associated with inference using a machine learning model.

In some embodiments, a machine learning model, such as model 160, may be (or may correspond to) one or more computer programs executed by processor(s) of server machine 140 and/or server machine 150. In other embodiments, a machine learning model may be (or may correspond to) one or more computer programs executed across a number or combination of server machines. For example, in some embodiments, machine learning models may be hosted on the cloud, while in other embodiments, these machine learning models may be hosted and perform operations using the hardware of a client device 110. In some embodiments, the machine learning models may be a self-hosted machine learning model, while in other embodiments, machine learning models may be external machine learning models accessed by an API.

In some embodiments, server machines 130 through 150 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to one or more data items of the security platform 120. The security platform 120 can also include a website (e.g., a webpage) or application back-end software that can be used to provide users with access to the security platform 120.

In some embodiments, one or more of server machine 130, server machine 140, model 160, server machine 150 can be part of security platform 120. In other embodiments, one or more of server machine 130, server machine 140, server machine 150, or model 160 can be separate from security platform 120 (e.g., provided by a third-party service provider).

Also as noted above, for purposes of illustration, rather than limitation, aspects of the disclosure describe the training of a machine learning model (e.g., model 160) and use of a trained machine learning model (e.g., model 160). In other embodiments, a heuristic model or rule-based model can be used as an alternative. It should be noted that in some other embodiments, one or more of the functions of security platform 120 can be provided by a greater number of machines. In addition, the functionality attributed to a particular component of the security platform 120 can be performed by different or multiple components operating together. Although embodiments of the disclosure are discussed in terms of security platforms, embodiments can also be generally applied to any type of platform or service.

In general, functions described in implementations as being performed by security platform 120, client 102, and/or server machine 140 can also be performed on the client device 110 in other implementations, if appropriate. In addition, the functionality attributed to a specific component can be performed by different or multiple components operating together. The security platform 120 can also be accessed as a service provided to other systems or devices through appropriate application programming interfaces, and thus is not limited to use in websites.

In implementations of the disclosure, a “user” can be represented as a single individual. For example, a user of the client device 110. However, other implementations of the disclosure encompass a “user” being an entity controlled by a set of users and/or an automated source (e.g., client 102). For example, a set of individual users federated as a community in a social network can be considered a “user.” In another example, an automated consumer can be an automated ingestion pipeline of security platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a specific location of a user cannot be determined. Thus, the user can have control over what information is collected about the user, how that information is used, and what information is provided to the user.

FIG. 2 is an example training set generator to generate training data for a machine learning model using information classification of log type, in accordance with aspects of the disclosure. System 200 shows a training set generator 131, training inputs 230, and target outputs 240. System 200 can include similar components as system 100, as described in FIG. 1. Components described with reference to system 100 of FIG. 1 can be used to describe system 200 of FIG. 2.

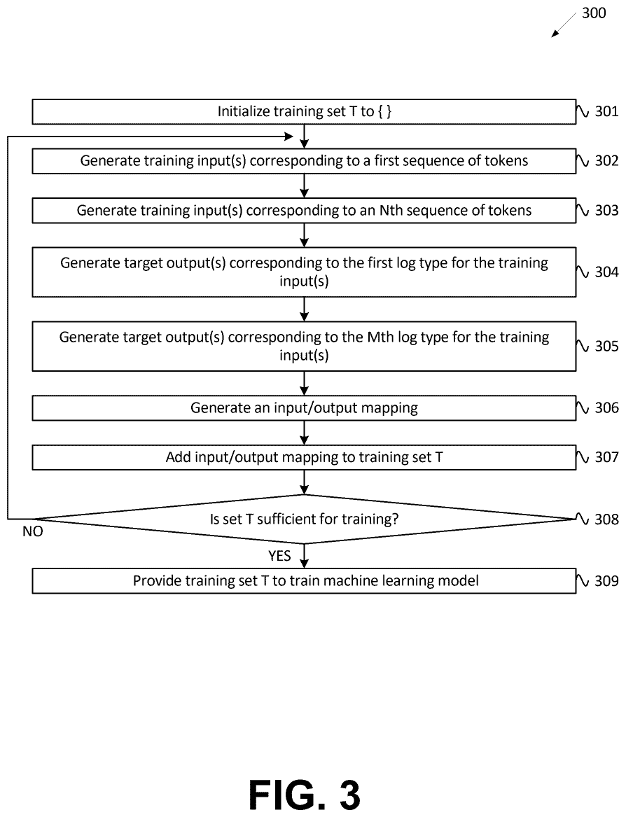

In some embodiments, training set generator 131 generates training data that includes one or more training inputs 230, and one or more target outputs 240. The training data can include mapping data that maps the training inputs 230 to the target outputs 240. Training inputs 230 can also be referred to as “features” or “attributes,” herein. In some embodiments, training set generator 131 can provide the training data in a training set, and provide the training set to the training engine 141 (not illustrated) where the training set is used to train the model 160. Generating a training set is further described with reference to FIG. 3.

The training set generator 131 can receive information representing logs from a client (e.g., training inputs 230) and generate labels reflecting log types of the input log information (e.g., target outputs 240). Historical coupled pairings of logs (inputs) and log types (outputs) can be used as training inputs 230 and target outputs 240 respectively to train an AI model to identify log types (output) based on input derived from logs (input). In some embodiments, historical log information for a log (e.g., the training input 230) is paired with a label reflecting a log type (e.g., the target output 240).

The training inputs 230 can include a first sequence of tokens 231A through Nth sequence of tokens 231N. For the purposes of brevity, characteristics of the first sequence of tokens 231A are described herein. Similar descriptions apply to the Nth sequence of tokens 231N, unless otherwise described. Each sequence of tokens reflects log content 153 from a log 152. As described above, a log refers to a record of events, activities, or transactions that occur within a system, network, or process. Similarly, log information can include data or metadata associated with the events, activities or transactions recorded in a log. As described above, training inputs 230 can include historical logs and corresponding historical log information.

A log (e.g., a historical log) can be received at the log classification module. The log classification module can perform one or more pre-processing operations on the log information (e.g., historical log information) contained in the log. The log classification module can provide training inputs 230 to the training set generator 131 to train the AI model to predict labels reflecting log types (e.g., historical log type). In some embodiments, the log classification module generates a first sequence of tokens 231A (representing historical log information of a first historical log) through an Nth sequence of tokens 231N (representing historical log information of an Nth historical log) to be used as input to the training set generator 131.

In some embodiments, the first sequence of tokens 231A is a first sequence of strings, as described with reference to FIG. 1, above. In some embodiments, the first sequence of tokens 231A is a first sequence of prevalent strings (e.g., based on a token vocabulary) as described with reference to FIG. 1, above.

The training inputs 230 are provided to the training set generator 131 to be used to train the model 160 to produce the target outputs 240 based on the training inputs 230.

The target outputs 240 can include a first log type 241A through Mth log type 241M. For the purposes of brevity, characteristics of the first log type 241A are described herein. Similar descriptions apply to the Mth log type 241M, unless otherwise described. The target outputs 240 further include a first level of confidence 242A that the first log type 241A applies to a particular input (e.g., a particular sequence of tokens), through an Mth level of confidence that the Mth log type 241M applies to the particular input. For the purposes of brevity, characteristics of the first level of confidence 242A are described herein. Similar descriptions apply to the Mth level of confidence 242M, unless otherwise described. As described above, a log type refers to an internal label assigned by the security platform to logs that are received from a client.

The first log type 241A can be a historical log type that was assigned to a historical log (e.g., in a historical log-to-log-type coupling). The first level of confidence 242A can be 1, provided that the first log type 241A was appropriately assigned to the first sequence of tokens 231A in the training data (e.g., training inputs 230 and target outputs 240).

Each training input 230 can be mapped to a target output 240 with a 1:1 mapping. During inference, the model 160 identifies a log type that applies to each sequence of tokens. In some embodiments, during inference, the model 160 can identify another log type (e.g., Mth log type 241M) that applies to a first sequence of tokens 231A in addition to a first log type 241A, however, only one of the log types will ultimately apply to the first sequence of tokens 231A. Thus, during training, there is a 1:1 mapping between a particular input (e.g., a first sequence of tokens 231A) and a corresponding first log type 241A.

In some embodiments, multiple sequences of tokens (inputs) can map to the same log type (output) (e.g., an X:1 mapping). For example, a first sequence of tokens 231A from Organization A and an Nth sequence of tokens 231N from Organization N can both map to a first log type 241A. In another example, a first sequence of tokens 231A from Organization A for Application X and an Nth sequence of tokens 231N from Organization A for Application Y can both map to a first log type 241A. In yet another example, a first sequence of tokens 231A from Organization A for Application X and an Nth sequence of tokens 231N from Organization N for Application Y can both map to a first log type 241A.

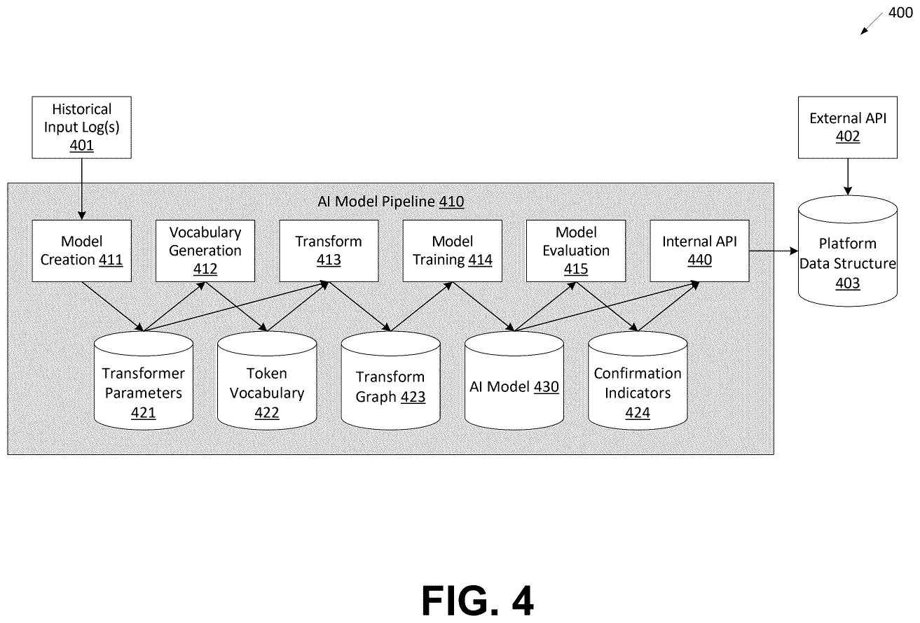

It can be appreciated that during training, and as implemented in the security platform, there are no one to multiple mappings (1:X mappings). That is, a given log input (represented by a first sequence of tokens 231A) is only usable by the security platform once a particular log type is identified, and a given log input cannot belong to multiple log types. However, during inference, further described with reference to FIG. 4 below, the model 160 may identify various potential log types (e.g., first log type 241A through Mth log type 241M) and corresponding levels of confidence (e.g., first level of confidence 242A through Mth level of confidence 242M).

The target outputs 240 are provided to the training set generator 131 to be used to train the model 160 to produce the target outputs 240 based on the training inputs 230.

FIG. 3 depicts a flow diagram of one example of a method 300 for training a AI model, in accordance with aspects of the disclosure. The method is performed by processing logic that can include hardware (circuitry, dedicated logic, etc.), software (e.g., instructions run on a processing device), or a combination thereof. In one embodiment, some or all the operations of method 300 can be performed by one or more components of system 100 FIG. 1. In other embodiments, one or more operations of method 300 can be performed by training set generator 131 of server machine 130 as described with reference to FIGS. 1-2 It can be noted that components described with respect to FIG. 1 through FIG. 2 can be used to help illustrate aspects of FIG. 3. In some embodiments, the operations (e.g., operations 301-309) can be the same, different, fewer, or greater. For instance, in some embodiments one or more training inputs can be generated or one or more target outputs can be generated, and the one or more training inputs and one or more training outputs can be used as input-output pairs (for input) to train the AI model, such as model 160, to be used by the log classification module 151.

Method 300 generates training data for an AI model. In some embodiments, at operation 301, the processing logic implementing the method 300 initializes the training set “T” to an empty set (e.g., “{ }”).

At operation 302, the processing logic generates training input(s) corresponding to a first sequence of tokens. The first sequence of tokens can reflect first log information contained in a first log. In some embodiments, the processing logic can generate a training input including information representing log information of a log received from a client. In some embodiments, the processing logic can generate a training input including information representing a sequence of characters reflecting log information received from a client. In some embodiments, the processing logic can preprocess data received from a client to generate the training input corresponding to the first sequence of tokens.

At operation 303, the processing logic generates training input(s) corresponding to an Nth sequence of tokens. The Nth sequence of tokens can reflect Nth log information contained in an Nth log. In some embodiments, the Nth sequence of tokens reflects an Nth log received from a particular organization. For example, Organization A can provide a first log through Nth log. In some embodiments, the Nth sequence of tokens reflects an Nth log received from any organization. For example, Organization A can provide a first log through Nth−1 log, and Organization B can provide the Nth log.

At operation 304, the processing logic generates target output(s) corresponding to the first log type for the training inputs. In some embodiments, the first training input (e.g., the first sequence of tokens) is paired with the first target output (e.g., the first log type). In some embodiments, the processing logic can generate a target output including a level of confidence that the first log type applies to the first log (e.g., the first sequence of tokens). In some embodiments, the Nth training input (e.g., the Nth sequence of tokens) is paired with the first target output (e.g., the first log type). In some embodiments, the processing logic generates a target output including a level of confidence that the first log type applies to the Nth log (e.g., the Nth sequence of tokens).

At operation 305, the processing logic generates target output(s) corresponding to the Mth log type for the training inputs. In some embodiments, the first training input (e.g., the first sequence of tokens) is paired with the Mth target output (e.g., the Mth log type). In some embodiments, the processing logic can generate a target output including a level of confidence that the Mth log type applies to the first log (e.g., the first sequence of tokens). In some embodiments, the Nth training input (e.g., the Nth sequence of tokens) is paired with the Mth target output (e.g., the Mth log type). In some embodiments, the processing logic generates a target output including a level of confidence that the Mth log type applies to the Nth log (e.g., the Nth sequence of tokens).

At operation 306, processing logic optionally generates mapping data that is indicative of an input/output mapping. The input/output mapping (or training set mapping data) can refer to the training input (e.g., one or more of the training inputs described herein), the set of target outputs for the training input (e.g., one or more of the target outputs described herein), and an association between the training input(s) and the target output(s).

At operation 307, processing logic adds the mapping data generated at operation 306 to the training set T.

At operation 308, processing logic branches based on whether training set T is sufficient for training the model 160. If so, execution proceeds to operation 309, otherwise, execution continues back at operation 302. It should be noted that in some embodiments, the sufficiency of training set T may be determined based simply on the number of input/output mappings in the training set, while in some other embodiments, the sufficiency of training set T may be determined based on one or more other criteria (e.g., a measure of diversity of the training examples, accuracy satisfying a threshold, etc.) in addition to, or instead of, the number of input/output mappings.

At operation 309, processing logic provides training set T to train the AI model (e.g., model 160). In one embodiment, training set T is provided to training engine 141 of server machine 140 to perform the training. In some embodiments, operation 309 can include training the AI model using the training set T. In the case of a neural network, for example, input values of a given input/output mapping (e.g., numerical values associated with training inputs 230) are input to the neural network, and output values (e.g., numerical values associated with target outputs 240) of the input/output mapping are stored in the output nodes of the neural network. The connection weights in the neural network are then adjusted in accordance with a learning algorithm (e.g., back propagation, etc.), and the procedure is repeated for the other input/output mappings in training set T. At operation 309, the AI model (e.g., model 160) can be trained using training engine 141 of server machine 140. The trained AI model (e.g., model 160) can be implemented by the log classification module 151 (of server machine 150, or security platform 120) to classify log types of logs provided to the security platform 120.

FIG. 4 illustrates an example block diagram of a system flow 400 for an AI model pipeline 410 for security log classification with the AI model, according to aspects of the disclosure.

Historical input logs 401 are collected from clients. In some embodiments, the security platform (e.g., the first-party organization) already has historical input logs that have been previously collected from clients.

During model creation 411, the historical input logs 401 are used to configure the transformer parameters 421 of the AI model 430. In some embodiments, a pre-trained model can be used as the initial framework for the AI model 430 during model creation 411. In such embodiments, applicable parameters from the pre-trained model can be used as initial values for the transformer parameters 421. In some embodiments, the model created at model creation 411 is a first AI model, used to generate a token vocabulary (e.g., the token vocabulary 422). A second AI model (e.g., the AI model 430) can be used to extract tokens from one or more inputs during inference.

In some embodiments, the transformer parameters 421 include parameters for converting the historical input logs into sequences of tokens. As described above, historical input logs can be received, and the corresponding historical log information can be converted from a sequence of characters into a sequence of strings. In some embodiments, the sequence of strings can be converted into a sequence of tokens, where each token is a prevalent string from a vocabulary of prevalent strings (e.g., a token vocabulary 422).

In some embodiments, the transformer parameters 421 include parameters for determining a token vocabulary 422 based on a prevalence of strings across the sequences of strings representing the historical input logs 401. In some embodiments, the transformer parameters 421 can include one or more frequency thresholds, string lengths, or character limitations.

During the vocabulary generation 412, transformer parameters can be applied to the historical input logs to generate the token vocabulary 422.

During the transform 413, the token vocabulary 422 and the transformer parameters can be used to generate the transform graph 423. In some embodiments, the transform graph maps one or more inputs to the AI model 430 to one or more outputs. In some embodiments, the transform graph maps one or more labeled inputs (e.g., training inputs) to one or more labeled outputs (e.g., target outputs). In some embodiments, the transform graph 423 can be a visual representation of mappings between inputs and outputs, along with associated transformer parameters (as applicable).

During model training 414, the transform graph 423 (e.g., the input to output mapping generated from the transformer parameters 421 and the token vocabulary 422 during the transform 413) is used to train the AI model 430.

Once trained, the AI model 430 can be evaluated during model evaluation 415. In some embodiments, model evaluation 415 can include re-training operations and/or fine-tuning training operations to adjust the AI model 430. In some embodiments, the model evaluation 415 can include one or more coupled pairs of inputs and outputs that are used to evaluate the performance of the AI model 430. For example, a test input A is coupled to a test output X. During model evaluation 415, it can be determined whether the AI model 430 produces the test output X from the test input A. In some embodiments, the AI model 430 is a separate model from the model created at the model creation 411. The AI model 430 that is used to extract tokens from one or more inputs can be a model that is fine-tuned or adjusted to use the token vocabulary 422 (e.g., generated by the AI model created at the model creation 411).

The model evaluation 415 can generate one or more confirmation indicators 424, reflecting the results of the model evaluation 415. These confirmation indicators 424 can verify that the AI model 430 is producing acceptable outputs. In some embodiments, the confirmation indicators 424 are provided along with the functionality of the AI model 430 to an Internal API 440.

The internal API 440 can make the AI model 430 available to the security platform (e.g., through platform data structure 403) provided by the first-party organization. In some embodiments, the internal API 440 can make one or more confirmation indicators 424 available to the security platform alongside the AI model 430. The internal API 440 allows the AI model 430 to be accessed by the security platform, for example, through the platform data structure 403.

The external API 402 can make the AI model 430 available to clients that use the security platform provided by the first party organization. In some embodiments, the input logs provided by the client(s) to the external API 402 are stored in the platform data structure 403. In some embodiments, input logs stored in the platform data structure 403 can be used as historical input logs 401 (e.g., for re-training).

In some embodiments, the AI model pipeline 410 can include a statistical analysis function or feature (e.g., generating mean, median, mode values corresponding to input features).

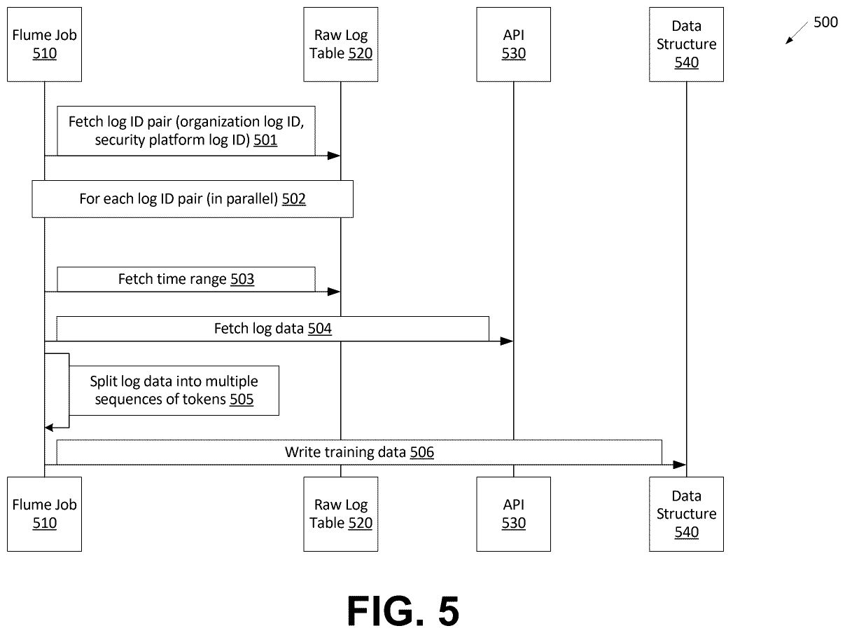

FIG. 5 illustrates an example swimlane diagram for a data flow 500 for performing security log type classification with an AI model, according to aspects of the disclosure. Flume job 510, raw log table 520, API 530, and data structure 540 represent data processes or locations of the data flow 500.

At operation 501, processing logic for the flume job 510 fetches log ID pairs from the raw log table 520. In some embodiments, the log ID pairing includes an organization log ID and a corresponding security platform ID. In some embodiments, the log ID pairs can be fetched for a particular customer, date range, log type, or the like. In some embodiments, information in the log ID pairs can include one or more of a number of log types for a given customer or a number of customers for a given log type. In some embodiments, the raw log table 520 can include one or more of information such as a identifier of the log (e.g., a file name), a timestamp for when the log was received, a severity, or the like.

At operation 502, the processing logic can process each fetched log ID pair. In some embodiments, two or more log ID pairs can be processed simultaneously (e.g., in parallel). In some embodiments, the processing logic can determine a time range (e.g., date range) for a customer from which to fetch log ID pairs. In some embodiments, the processing logic can determine a sampling rate of log ID pairs to fetch for a given customer. For example, given an exemplary predetermined training set size of ten thousand to identify a given log type, the processing logic can fetch five thousand log ID pairs from Organization A for the given log type and five thousand log ID pairs from Organization B to use as training data. In some embodiments, the sampling rate can be a percentage of logs received from a customer. For example, if Organization A has one million logs of a given log type (e.g., log ID pairs), the processing logic can determine a sampling rate to be 0.5% and the processing logic can fetch five thousand log ID pairs corresponding to the logs from Organization A. In some embodiments, the sampling rate can be a static value. In some embodiments, the static value can be based on a lowest quantity of logs provided by an organization.

At operation 503, as a part of the operation 502, the processing logic fetches a time range from the raw log table 520. In some embodiments, the time range can be based on a quantity of logs (e.g., a time period with a highest log amount) or recency of the logs (e.g., the most recent time range). In some embodiments, the length of the time range is configurable based on training data requirements to train the AI model.

At operation 504, as part of the operation 502, the processing logic fetches log data (e.g., logs containing log information from an organization) for the determined time range, using the API 530.

At operation 505, the log data is split into multiple sequences of tokens. That is, for each log received from an organization, the log information contained in the respective log is converted into a sequence of tokens. As described above, and in some embodiments, the log information is represented by a sequence of characters that are parsed into a sequence of strings and converted into a sequence of tokens by selecting prevalent strings from the sequence of strings based on a token vocabulary.

At operation 506, the sequences of tokens are written to the data structure 540. In some embodiments, the data structure 540 can be the same as or similar to one or more of the data structure 106 of FIG. 1, or the platform data structure 403 of FIG. 4. In some embodiments, the AI model (e.g., model 160 of FIG. 1) can be trained based on training data (e.g., training inputs and corresponding target outputs) stored to the data structure 540.

FIG. 6A illustrates an example method 600 for predicting a security log type classification with an artificial intelligence model, according to aspects of the disclosure. Method 600 can be performed by processing logic that can include hardware (circuitry, dedicated logic, etc.), software (e.g., instructions run on a processing device), or a combination thereof. In one implementation, some, or all of the operations of method 600 can be performed by one or more components of system 100 of FIG. 1. In some implementations, some, or all of the operations of method 600 can be performed by the log classification module 151 as described above.

At operation 601, the processing logic performing the method 600 obtains a log comprising a sequence of characters. In some embodiments, the sequence of characters represents the log content of the log.

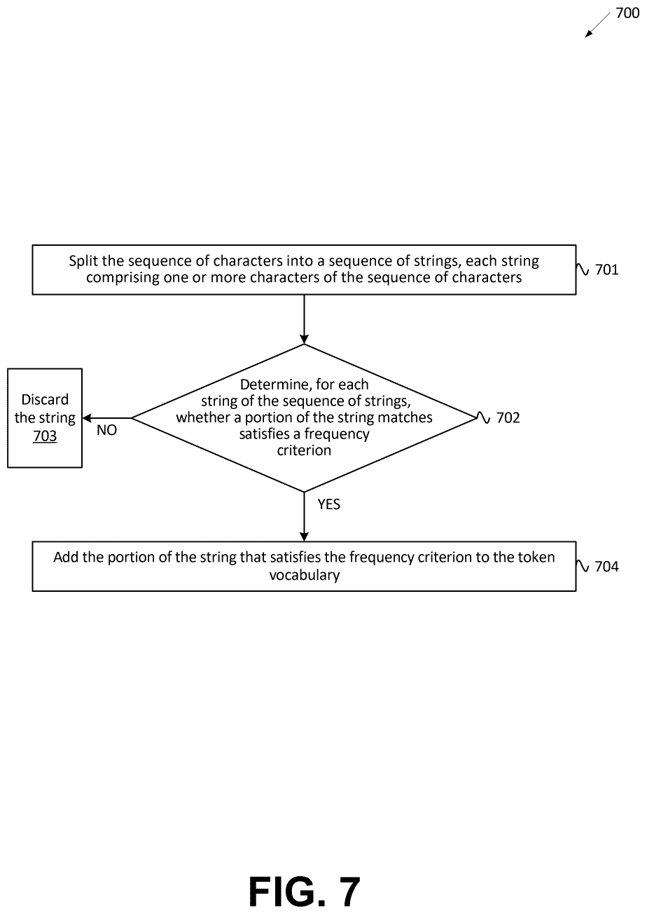

At operation 602, the processing logic extracts, using a token vocabulary, a sequence of tokens from the sequence of characters using a token vocabulary. In some embodiments, the token vocabulary includes prevalent strings from across multiple logs. Additional details regarding determining the sequence of tokens are described with reference to method 650 of FIG. 6B, below. Additional details regarding the token vocabulary are described with reference to method 700 of FIG. 7, below.

At operation 603, the processing logic provides the sequence of tokens as input to a trained artificial intelligence (AI) model.

At operation 604, the processing logic obtains one or more outputs from the trained AI model.

At operation 605, the processing logic extracts, from the one or more outputs, (i) a label reflecting a type of log, and (ii) a level of confidence that the label applies to the log. In some embodiments, the processing logic can additionally extract, from the one or more outputs, an indication of security information. In some embodiments, security information includes one or more of a security action, security platform configuration parameter, or security information report that applies to the received log. In some embodiments, the processing logic determines whether there are one or more of a security action, security platform configuration parameter, or security information report that applies to the log, based on the label reflecting the log type. In some embodiments, the security action, security platform configuration parameter, or security information report suggestion can be determined based on actions, configuration parameters, or information reports implemented for other organizations with logs that have the same label reflecting the same log type.

At operation 606, an optional operation, the processing logic extracts, from the one or more outputs, (iii) a second label reflecting a second log type, and (iv) a second level of confidence that the second label applies to the log.

At operation 607, the processing logic determines whether the level of confidence satisfies a threshold criterion.

At operation 608, responsive to determining the level of confidence satisfies a threshold criterion at operation 607, the processing logic assigns the label to the log.

At operation 609, responsive to determining the level of confidence does not satisfy the threshold criterion at operation 607, the processing logic causes a visual representation of (i) the label reflecting the type of log and (ii) the level of confidence that the label applies to the log to be visually rendered via a graphical user interface (GUI) in association with a prompt a selected label associated with the log. In some embodiments, the processing logic can cause an indication of security information associated with the log label to be visually rendered in the GUI.

At operation 610, the processing logic assigns the selected label to the log.

FIG. 6B illustrates an example method 650 for predicting a security log type classification with an artificial intelligence model, according to aspects of the disclosure. Method 600 can be performed by processing logic that can include hardware (circuitry, dedicated logic, etc.), software (e.g., instructions run on a processing device), or a combination thereof. In one implementation, some, or all of the operations of method 650 can be performed by one or more components of system 100 of FIG. 1. In some implementations, some, or all of the operations of method 650 can be performed by the log classification module 151 as described above.

In some embodiments, the operations of method 650 can be performed in place of, in addition to, or as a part of the operation 602 of method 600.

At operation 651, the processing logic performing the method 650 splits the sequence of characters into a sequence of strings, each string comprising one or more characters of the sequence of characters.

At operation 652, the processing logic determines for each string of the sequence of strings, whether a portion of the string matches a token of the token vocabulary.

At operation 653, responsive to determining the portion of the string does not match the token of the token vocabulary at operation 652, the processing logic discards the whole string. In some embodiments, responsive to determining the portion of the string does not match the token of the token vocabulary at operation 652, the processing logic reverts to a character-by-character token recognition. In some embodiments, character-by-character token recognition can be used to identify and add new tokens to the token vocabulary.

At operation 654, responsive to determining the portion of the string matches the token of the token vocabulary at operation 652, the processing logic discards a remainder of the string. In some embodiments, the portion of the string that matches the token of the token vocabulary is the full string, e.g., there is no remaining portion of the string to be discarded. In some embodiments, the processing logic can determine whether a second portion of the string matches a second token of the token vocabulary.

FIG. 7 illustrates an example method 700 for predicting a security log type classification with an artificial intelligence model, according to aspects of the disclosure. Method 700 can be performed by processing logic that can include hardware (circuitry, dedicated logic, etc.), software (e.g., instructions run on a processing device), or a combination thereof. In one implementation, some, or all of the operations of method 700 can be performed by one or more components of system 100 of FIG. 1. In some implementations, some, or all of the operations of method 700 can be performed by the log classification module 151 as described above.

At operation 701, the processing logic performing the method 700 splits the sequence of characters into a sequence of strings, each string comprising one or more characters of the sequence of characters.

At operation 702, the processing logic determines for each string of the sequence of strings, whether a portion of the string satisfies a frequency criterion.

At operation 703, responsive to determining the portion of the string does not match the token of the token vocabulary at operation 702, the processing logic discards the string.

At operation 704, responsive to determining that the portion of the string does match the token of the token vocabulary at operation 702, the processing logic adds the portion of the string that satisfies the frequency criterion to the token vocabulary.

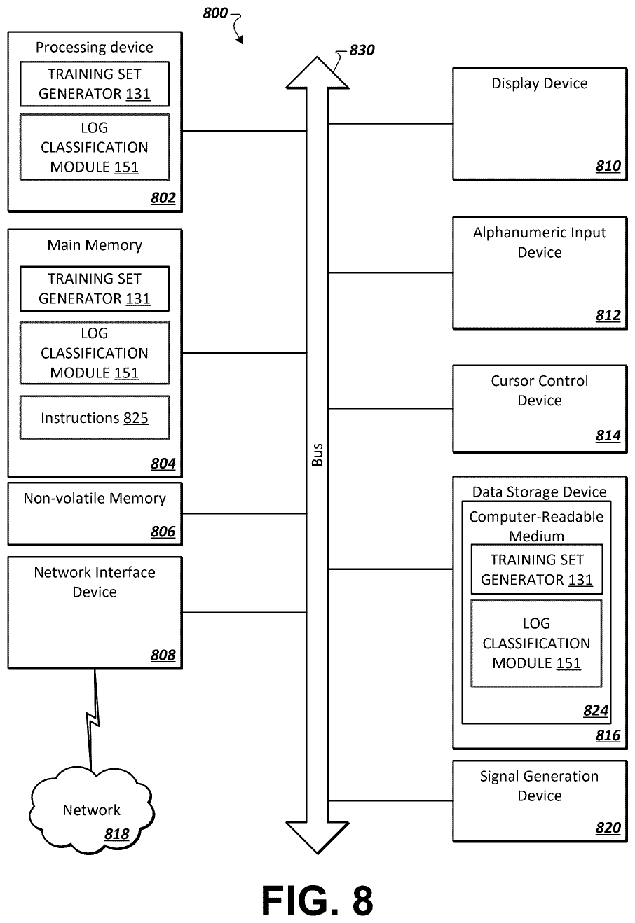

FIG. 8 is a block diagram illustrating an example of a computer system 800, according to aspects of the disclosure. The computer system 800 can correspond to security platform 120 and/or client devices 102A-N, described in FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 includes a processing device 802 (e.g., a processor), a main memory 804 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 806 (e.g., flash memory, static random access memory (SRAM), etc.), and a data storage device 816, which communicate with each other via a bus 830. In some embodiments, the main memory 804 can be a non-transitory computer readable storage medium.

Processing device 802 represents one or more general-purpose processing devices such as a microprocessor, central processing unit, or the like. More specifically, processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute network interface device 808 (e.g., for synchronizing data between platforms) for performing the operations discussed herein. The processing device 802 can be configured to execute instructions 825 stored in main memory 804. Non-volatile memory 806 can store the instructions 825 when they are not being executed, and can store additional system data that can be accessed by processing device 802.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a computer-readable storage medium 824 (e.g., a non-transitory machine-readable storage medium) on which is stored one or more sets of instructions 825 (e.g., for generating variations of a translated audio portion) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over a network 820 via the network interface device 808.

While the computer-readable storage medium 824 (machine-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a specific feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining a log comprising a sequence of characters;
generating a plurality of strings comprising a sequence of strings, wherein generating the plurality of strings comprises:
splitting the sequence of characters into the sequence of strings each respective string comprising at least one character of the first sequence of characters, and
determining, for each string of the plurality of strings, whether a portion of the string satisfies a frequency criterion;
responsive to determining that the portion of the string satisfies the frequency criterion, adding the portion of the string that satisfies the frequency criterion to the token vocabulary;
extracting, using the token vocabulary, a sequence of tokens from the sequence of characters; and
determining, based on the sequence of tokens, (i) a label reflecting a type of log, and (ii) a level of confidence that the label applies to the log.

2. The method of claim 1, wherein extracting the sequence of tokens from the sequence of characters further comprises:
splitting the sequence of characters into a sequence of strings, each string comprising at least one character of the sequence of characters;
determining, for each string of the sequence of strings, whether a portion of the string matches a token of the token vocabulary;
responsive to determining that the portion of the string matches the token, discarding a remainder of the string.

3. The method of claim 1, further comprising:
determining whether the level of confidence satisfies a threshold criterion; and
responsive to determining the level of confidence satisfies the threshold criterion, assigning the label to the log.

4. The method of claim 1, further comprising:
determining whether the level of confidence satisfies a threshold criterion; and
responsive to determining that the level of confidence does not satisfy the threshold criterion, causing a visual representation of (i) the label reflecting the type of log and (ii) the level of confidence that the label applies to the log to be visually rendered via a graphical user interface (GUI) in association with a prompt to select a selected label to be associated with the log; and
assigning the selected label to the log.

5. The method of claim 1, further comprising:
extracting, from the one or more outputs, (iii) an indication of a second label, and (iv) a second level of confidence that the second label applies to the log.

6. The method of claim 1, further comprising extracting, from the one or more outputs (iii) an indication of security information, and (iv) a second level of confidence that the security information applies to the log.

7. The method of claim 1, further comprising:
splitting the sequence of characters into a sequence of strings, each string comprising at least one character of the sequence of characters;
determining, for each string of the sequence of strings, whether a portion of the string satisfies a frequency criterion;
responsive to determining that the portion of the string satisfies the frequency criterion, adding the portion of the string that satisfies the frequency criterion to the token vocabulary.

8. The method of claim 1, wherein determining, based on the sequence of tokens comprises:
providing the sequence of tokens as input to a trained artificial intelligence (AI) model;
obtaining one or more outputs from the trained AI model; and
extracting, from the one or more outputs, (i) the label reflecting the type of log, and (ii) the level of confidence that the label applies to the log.

9. A non-transitory computer readable storage medium comprising instructions for a server that, when executed by a processing device, cause the processing device to perform operations comprising:
obtaining a log comprising a sequence of characters;
generating a plurality of strings comprising a sequence of strings, wherein generating the plurality of strings comprises:
splitting the sequence of characters into the sequence of strings each respective string comprising at least one character of the first sequence of characters, and
determining, for each string of the plurality of strings, whether a portion of the string satisfies a frequency criterion;
responsive to determining that the portion of the string satisfies the frequency criterion, adding the portion of the string that satisfies the frequency criterion to the token vocabulary;
extracting, using the token vocabulary, a sequence of tokens from the sequence of characters; and
determining, based on the sequence of tokens, (i) a label reflecting a type of log, and (ii) a level of confidence that the label applies to the log.

10. The non-transitory computer readable storage medium of claim 9, the operations further comprising:
splitting the sequence of characters into a sequence of strings, each string comprising at least one character of the sequence of characters;
determining, for each string of the sequence of strings, whether a portion of the string matches a token of the token vocabulary;
responsive to determining that the portion of the string matches the token, discarding a remainder of the string.

11. The non-transitory computer readable storage medium of claim 9, the operations further comprising:
determining whether the level of confidence satisfies a threshold criterion; and
responsive to determining the level of confidence satisfies the threshold criterion, assigning the label to the log.

12. The non-transitory computer readable storage medium of claim 9, the operations further comprising:
determining whether the level of confidence satisfies a threshold criterion;
responsive to determining that the level of confidence does not satisfy the threshold criterion, causing a visual representation of (i) the label and (ii) the level of confidence that the label applies to the log to be visually rendered via a graphical user interface (GUI) in association with a prompt to select a selected label to be associated with the log; and
assigning the selected label to the log.

13. The non-transitory computer readable storage medium of claim 9, further comprising:
extracting, from the one or more outputs, (iii) an indication of a second label, and (iv) a second level of confidence that the second label applies to the log.

14. The non-transitory computer readable storage medium of claim 9, further comprising extracting, from the one or more outputs (iii) an indication of security information, and (iv) a second level of confidence that the security information applies to the log.

15. The non-transitory computer readable storage medium of claim 9, further comprising:
splitting the sequence of characters into a sequence of strings, each string comprising at least one character of the sequence of characters;
determining, for each string of the sequence of strings, whether a portion of the string satisfies a frequency criterion;
responsive to determining that the portion of the string satisfies the frequency criterion, adding the portion of the string that satisfies the frequency criterion to the token vocabulary.

16. The non-transitory computer readable storage medium of claim 9, wherein determining, based on the sequence of tokens comprises:
providing the sequence of tokens as input to a trained artificial intelligence (AI) model;
obtaining one or more outputs from the trained AI model; and
extracting, from the one or more outputs, (i) the label reflecting the type of log, and (ii) the level of confidence that the label applies to the log.

17. A system comprising:
a memory; and
one or more processing devices coupled with the memory, the one or more processing devices to perform operations comprising:
obtaining a log comprising a sequence of characters;
generating a plurality of strings comprising a sequence of strings, wherein generating the plurality of strings comprises:
splitting the sequence of characters into the sequence of strings each respective string comprising at least one character of the first sequence of characters, and
determining, for each string of the plurality of strings, whether a portion of the string satisfies a frequency criterion;
responsive to determining that the portion of the string satisfies the frequency criterion, adding the portion of the string that satisfies the frequency criterion to the token vocabulary;
extracting, using the token vocabulary, a sequence of tokens from the sequence of characters; and
determining, based on the sequence of tokens, (i) a label reflecting a type of log, and (ii) a level of confidence that the label applies to the log.

18. The system of claim 17, the operations further comprising:
splitting the sequence of characters into a sequence of strings, each string comprising at least one character of the sequence of characters;
determining, for each string of the sequence of strings, whether a portion of the string matches a token of the token vocabulary;
responsive to determining that the portion of the string matches the token, discarding a remainder of the string.

19. The system of claim 17, the operations further comprising:
determining whether the level of confidence satisfies a threshold criterion; and
responsive to determining the level of confidence satisfies the threshold criterion, assigning the label to the log.

20. The system of claim 17, the operations further comprising:
determining whether the level of confidence satisfies a threshold criterion;
responsive to determining that the level of confidence does not satisfy the threshold criterion, causing a visual representation of (i) the label and (ii) the level of confidence that the label applies to the log to be visually rendered via a graphical user interface (GUI) in association with a prompt to select a selected label to be associated with the log; and
assigning the selected label to the log.
